(19) United States
(12) Patent Application Publication
(10) Pub. No.: US 2023/0281585 A1
(43) Pub. Date: Sep. 7, 2023

(54) Systems and Methods for Managing Network-Agnostic Smart Contracts

(71) Applicant: CXIP Labs, Inc., Los Angeles, CA (US)

(72) Inventor: Vitaliy Kechik, Paris (FR)

(21) Appl. No.: 18/179,773

(22) Filed: Mar. 7, 2023

Related U.S. Application Data
(60) Provisional application No. 63/317,343, filed on Mar. 7, 2022.

(51) Int. Cl. G06Q 20/12; G06F 21/10

(52) U.S. Cl. CPC G06Q 20/1235; G06F 21/10; G06Q 2220/16; G06F 2221/0711

(57) ABSTRACT

In an aspect, an apparatus for managing smart contracts is presented. The apparatus includes at least a processor and a memory communicatively connected to the at least a processor. The memory contains instructions configured the at least a processor to generate a smart contract. The smart contract comprises at least a non-fungible token (NFT) having a unique token identification and a unique digital address. The at least a processor is configured to bridge the smart contract to a virtual machine. The at least a processor is configured to deploy the smart contract, wherein upon deployment a replica of the at least a NFT is generated. The replica has the same unique token identification as the at least a non-fungible token.

### TECHNICAL FIELD

The subject matter of this application relates generally to using distributed ledger technology to create, authenticate and track contractual obligations, and, more specifically, to techniques and supporting systems for managing smart contracts across heterogeneous blockchain networks.

### BACKGROUND

A use of blockchain and smart contract technology is the creation and tracking of non-fungible tokens (“NFTs”), which is a digital asset that can be used to represent a real-world object such as art, music, collectables, etc. A system and method for managing smart contracts is provided herein.

### SUMMARY

In an aspect, an apparatus for managing smart contracts is presented. The apparatus includes at least a processor and a memory communicatively connected to the at least a processor. The memory contains instructions configured the at least a processor to generate a smart contract. The smart contract comprises at least a non-fungible token (NFT) having a unique token identification and a unique digital address. The at least a processor is configured to bridge the smart contract to a virtual machine. The at least a processor is configured to deploy the smart contract, wherein upon deployment a replica of the at least a NFT is generated. The replica has the same unique token identification as the at least a non-fungible token.

In an aspect, a method of managing smart contracts using a computing device is presented. The method includes generating a smart contract. The smart contract comprises at least a non-fungible token (NFT) having a unique token identification and a unique digital address. The method includes bridging the smart contract to a virtual machine. The method includes deploying the smart contract, wherein upon deployment a replica of the at least a NFT is generated. The replica has the same unique token identification as the at least a NFT.

### BRIEF DESCRIPTION OF THE DRAWINGS

FIG. 1 illustrates an exemplary embodiment of an immutable sequential listing;

FIG. 2 illustrates an exemplary embodiment of a plurality of validator nodes;

FIG. 3 illustrates an exemplary embodiment of a system of communication through a plurality of validator nodes;

FIG. 4 illustrates an exemplary embodiment of a smart contract;

FIG. 5 illustrates a block diagram of a system for managing smart contracts;

FIG. 6 is a flow chart of a method of managing smart contracts; and

FIG. 7 illustrates a computing system that can be used to implement any one or more of the methodologies disclosed herein and any one or more portions thereof.

### DETAILED DESCRIPTION

In some embodiments, aspects of the present disclosure provide methods and supporting systems that facilitate seamless and network agnostic creation and monitoring of smart contracts for non-fungible tokens (“NFTs”), which may allow NFTs to be bridged to any Ethereum virtual machine (“EVM”) compatible chain while maintaining a consistent smart contract address and token id. In an embodiment, an exact replica of a non-fungible-token is cloned onto an EVM chain and combined with a specific set of rules/restrictions. The NFT can “travel” freely among blockchains, while still maintaining its non-fungible attributes. In another aspect, the present disclosure can be used to facilitate the use of a single, unique smart contract address and token ID across all blockchains, thus making the smart contract address and token ID the definitive identifying characteristics of the token and guaranteeing a secure, non-fungible copy/transfer of an NFT from and into any other blockchain.

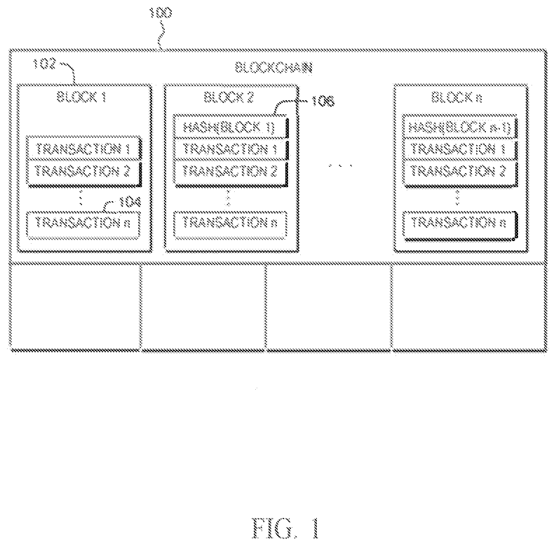

With reference now to FIG. 1, an immutable sequential listing 100 is shown. An “immutable sequential listing,” as used in this disclosure, is a data structure that places data entries in a fixed sequential arrangement, such as a temporal sequence of entries and/or blocks thereof, where the sequential arrangement, once established, cannot be altered or reordered. Immutable sequential listing 200 may be, include and/or implement an immutable ledger, where data entries that have been posted to immutable sequential listing 200 cannot be altered. In some embodiments, immutable sequential listing 200 may be utilized in a smart contract. A “smart contract” as used in this disclosure is a self-executing contract with the terms of agreement between a buyer and a seller being directly written into lines of code. Immutable sequential listing 200 may be utilized in a smart contract to unalterably store transactional data such as, but not limited to, identification of parties, transferred assets, values of assets, dates, times, ownership information, and the like.

Referring still to FIG. 1, immutable sequential listing may include data elements 102. Data elements 104 may include any form of data, including textual data, image data, encrypted data, cryptographically hashed data, and the like. A collection of textual data of data elements 104 may contain any textual data, including without limitation American Standard Code for Information Interchange (ASCII), Unicode, or similar computer-encoded textual data, any alphanumeric data, punctuation, diacritical mark, or any character or other marking used in any writing system to convey information, in any form, including any plaintext or cyphertext data. In an embodiment, a collection of textual data may be encrypted and/or may be a hash of other data. For instance, a collection of textual data may include a root or node of a Merkle tree or hash tree, or a hash of any other information desired to be recorded in some fashion using a digitally signed assertion. Data elements 104 may include, without limitation, one or more digitally signed assertions. Digitally signed assertions may include a collection of textual and/or other data that is signed using a secure proof. A digitally signed assertion 104 may be signed by a digital signature created using the private key associated with the owner's public key. In some embodiments, a collection of textual data may state that the owner of a certain transferable item represented in a digitally signed assertion register is transferring that item to the owner of an address.

Still referring to FIG. 1, a digitally signed assertion may describe a transfer of virtual currency, such as crypto-currency. Virtual currency may be a digital currency. In some embodiments, data elements 104 may include an item of value. An item of value may be a transfer of trust, for instance represented by a statement vouching for the identity or trustworthiness of the first entity, without limitation. An item of value may be an interest in a fungible negotiable financial instrument representing ownership in a public or private corporation, a creditor relationship with a governmental body or a corporation, rights to ownership represented by an option, derivative financial instrument, commodity, debt-backed security such as a bond or debenture or other security. A digitally signed assertion of data elements 104 may describe a transfer of a physical good and/or a digital good. For instance, a digitally signed assertion may describe a sale of a product or other physical asset. In some embodiments, a transfer nominally of one item may be used to represent a transfer of another item. For instance, a transfer of virtual currency may be interpreted as representing a transfer of an access right. In some embodiments, where an item nominally transferred is something other than virtual currency, the transfer itself may still be treated as a transfer of virtual currency, having value that depends on a variety of potential factors including the value of the item nominally transferred and the monetary value attendant to having the output of the transfer moved into a particular user's control. An item of value may be associated with a digitally signed assertion by means of an exterior protocol, such as the COLORED COINS created according to protocols developed by The Colored Coins Foundation, the MASTERCOIN protocol developed by the Mastercoin Foundation, or the ETHEREUM platform offered by the Stiftung Ethereum Foundation of Baar, Switzerland, the Thunder protocol developed by Thunder Consensus, or any other protocol.

Still referring to FIG. 1, in one embodiment, immutable sequential listing 100 and/or data elements 104 may include an address. An address may include a textual datum identifying the recipient of virtual currency or another item of value in a digitally signed assertion. In some embodiments, an address may be linked to a public key, the corresponding private key of which is owned by the recipient of a digitally signed assertion. For instance, an address may be the public key. An address may be a representation, such as a hash, of the public key. An address may be linked to the public key in memory of a computing device, for instance via a “wallet shortener” protocol. In some embodiments, where an address is linked to a public key, a transferee in a digitally signed assertion may record a subsequent digitally signed assertion transferring some or all of the value transferred in the first a digitally signed assertion to a new address in the same manner. A digitally signed assertion may contain textual information that is not a transfer of some item of value in addition to, or as an alternative to, such a transfer. For instance, as described in further detail below, a digitally signed assertion may indicate a confidence level associated with a distributed storage node as described in further detail below.

In an embodiment, and still referring to FIG. 1 immutable sequential listing 100 may record a series of at least a posted content in a way that preserves the order in which the at least a posted content took place. Immutable sequential listing 100 may be accessible at any of a various security settings. For instance, and without limitation, immutable sequential listing 100 may be readable and modifiable publicly, may be publicly readable but writable only by entities and/or devices having access privileges established by password protection, confidence level, or any device authentication procedure or facilities described herein, or may be readable and/or writable only by entities and/or devices having such access privileges. Access privileges may exist in more than one level, including, without limitation, a first access level or community of permitted entities and/or devices having ability to read, and a second access level or community of permitted entities and/or devices having ability to write; first and second community may be overlapping or non-overlapping. In an embodiment, posted content and/or immutable sequential listing 100 may be stored as one or more zero knowledge sets (ZKS), Private Information Retrieval (PIR) structure, or any other structure that allows checking of membership in a set by querying with specific properties. Such database may incorporate protective measures to ensure that malicious actors may not query the database repeatedly in an effort to narrow the members of a set to reveal uniquely identifying information of a given posted content.

Still referring to FIG. 1, immutable sequential listing 100 may preserve the order in which the at least a posted content took place by listing them in chronological order. Alternatively or additionally, immutable sequential listing 100 may organize data elements 104 into sub-listings 102 such as “blocks” in a blockchain, which may be themselves collected in a temporally sequential order. Data elements 104 within a sub-listing 102 may be temporally sequential. A ledger of immutable sequential listing 100 may preserve an order in which data of data elements 104 took place by listing them in sub-listings 102 and placing the sub-listings 102 in chronological order. Immutable sequential listing 100 may be a distributed, consensus-based ledger. In some embodiments, the ledger may be a secured ledger. In one embodiment, a secured ledger may include a ledger having safeguards against alteration by unauthorized parties. The ledger may be maintained by a proprietor, such as a system administrator on a server, that controls access to the ledger; for instance, the user account controls may allow contributors to the ledger to add at least a posted content to the ledger, but may not allow any users to alter at least a posted content that have been added to the ledger. In some embodiments, ledger is cryptographically secured; in one embodiment, a ledger is cryptographically secured where each link in the chain contains encrypted or hashed information that makes it practically infeasible to alter the ledger without betraying that alteration has taken place, for instance by requiring that an administrator or other party sign new additions to the chain with a digital signature. Immutable sequential listing 100 may be incorporated in, stored in, or incorporate, any suitable data structure, including without limitation any database, datastore, file structure, distributed hash table, directed acyclic graph or the like. In some embodiments, the timestamp of an entry is cryptographically secured and validated via trusted time, either directly on the chain or indirectly by utilizing a separate chain. In one embodiment the validity of timestamp is provided using a time stamping authority as described in the RFC 3161 standard for trusted timestamps, or in the ANSI ASC x9.95 standard. In another embodiment, the trusted time ordering is provided by a group of entities collectively acting as the time stamping authority with a requirement that a threshold number of the group of authorities sign the timestamp.

In some embodiments, and with continued reference to FIG. 1, immutable sequential listing 100, once formed, may be inalterable by any party, no matter what access rights that party possesses. For instance, immutable sequential listing 100 may include a hash chain, in which data is added during a successive hashing process to ensure non-repudiation. Immutable sequential listing 100 may include a block chain. In one embodiment, a block chain is immutable sequential listing 100 that records one or more new at least a posted content in a data item known as a sub-listing 102 or “block.” An example of a block chain is the BITCOIN block chain used to record BITCOIN transactions and values. Sub-listings 102 may be created in a way that places the sub-listings 102 in chronological order and link each sub-listing 102 to a previous sub-listing 102 in the chronological order so that any computing device may traverse the sub-listings 102 in reverse chronological order to verify any at least a posted content listed in the block chain. Each new sub-listing 102 may be required to contain a cryptographic hash describing the previous sub-listing 102, such as hash 106. In some embodiments, the block chain contains a single first sub-listing 102 sometimes known as a “genesis block.”

Still referring to FIG. 1, the creation of a new sub-listing 102 may be computationally expensive; for instance, the creation of a new sub-listing 102 may be designed by a “proof of work” protocol accepted by all participants in forming the immutable sequential listing 100 to take a powerful set of computing devices a certain period of time to produce. Where one sub-listing 102 takes less time for a given set of computing devices to produce the sub-listing 102 protocol may adjust the algorithm to produce the next sub-listing 102 so that it will require more steps; where one sub-listing 102 takes more time for a given set of computing devices to produce the sub-listing 102 protocol may adjust the algorithm to produce the next sub-listing 102 so that it will require fewer steps. As an example, protocol may require a new sub-listing 102 to contain a cryptographic hash describing its contents; the cryptographic hash may be required to satisfy a mathematical condition, achieved by having the sub-listing 102 contain a number, called a nonce, whose value is determined after the fact by the discovery of the hash that satisfies the mathematical condition. Continuing the example, the protocol may be able to adjust the mathematical condition so that the discovery of the hash describing a sub-listing 102 and satisfying the mathematical condition requires more or less steps, depending on the outcome of the previous hashing attempt. Mathematical condition, as an example, might be that the hash contains a certain number of leading zeros and a hashing algorithm that requires more steps to find a hash containing a greater number of leading zeros, and fewer steps to find a hash containing a lesser number of leading zeros. In some embodiments, production of a new sub-listing 102 according to the protocol is known as “mining.” The creation of a new sub-listing 102 may be designed by a “proof of stake” protocol as will be apparent to those skilled in the art upon reviewing the entirety of this disclosure.

With continued reference to FIG. 1, where two entities simultaneously create new sub-listings 102, immutable sequential listing 100 may develop a fork. A protocol may determine which of the two alternate branches in the fork is the valid new portion of the immutable sequential listing 100 by evaluating, after a certain amount of time has passed, which branch is longer. “Length” may be measured according to the number of sub-listings 102 in the branch. Length may be measured according to the total computational cost of producing the branch. Protocol may treat only at least a posted content contained the valid branch as valid at least a posted content. When a branch is found invalid according to this protocol, at least a posted content registered in that branch may be recreated in a new sub-listing 102 in the valid branch; the protocol may reject “double spending” at least a posted content that transfer the same virtual currency that another at least a posted content in the valid branch has already transferred. As a result, in some embodiments the creation of fraudulent at least a posted content requires the creation of a longer immutable sequential listing 100 branch by the entity attempting the fraudulent at least a posted content than the branch being produced by the rest of the participants; as long as the entity creating the fraudulent at least a posted content is likely the only one with the incentive to create the branch containing the fraudulent at least a posted content, the computational cost of the creation of that branch may be practically infeasible, guaranteeing the validity of all at least a posted content in the immutable sequential listing 100.

With continued reference to FIG. 1, in some embodiments, virtual currency, such as crypto-currency, may utilize one or more immutable sequential listings 100. Crypto-currency may include Bitcoins, Peercoins, Namecoins, and/or Litecoins. Crypto-currency may be decentralized, with no particular entity controlling it; the integrity of the crypto-currency may be maintained by adherence by its participants to established protocols for exchange and for production of new currency, which may be enforced by software implementing the crypto-currency. Crypto-currency may be centralized, with its protocols enforced or hosted by a particular entity. For instance, crypto-currency may be maintained in a centralized ledger. In lieu of a centrally controlling authority, such as a national bank, to manage currency values, the number of units of a particular crypto-currency may be limited; the rate at which units of crypto-currency enter the market may be managed by a mutually agreed-upon process, such as creating new units of currency when mathematical puzzles are solved, the degree of difficulty of the puzzles being adjustable to control the rate at which new units enter the market. Mathematical puzzles may be the same as the algorithms used to make productions of sub-listings 102 in a block chain computationally challenging; the incentive for producing sub-listings 102 may include the grant of new crypto-currency to the miners. Quantities of crypto-currency may be exchanged as described above.

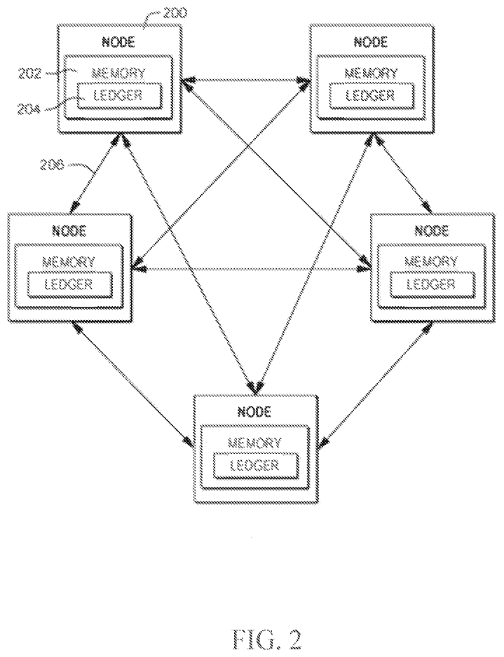

With reference now to FIG. 2, in some aspects, an immutable sequential listing may be stored in a decentralized manner on a plurality of nodes 200, e.g., computing devices located in one or more networks. Nodes 200 may each include a memory 202 that stores at least a portion of a ledger 204 of an immutable sequential listing. Ledger 204 includes any data blocks that have been validated and added to an immutable sequential listing. In some aspects, every node 200 may store the entire ledger 204. In some aspects, each node 200 may store a portion of ledger 204. In some aspects, some or all of an immutable sequential listing may be stored in a centralized manner. Nodes 200 may communicate with one another via communication pathways 206, e.g., wired or wireless connections, over the internet, etc. to transmit and receive data related to ledger 204. For example, as new data blocks are added to ledger 204, nodes 200 may communicate or share the new data blocks via communication pathways 206.

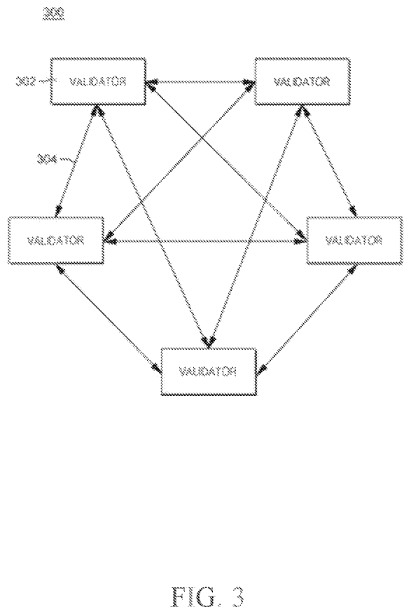

With reference now to FIG. 3, in some embodiments, any transactions submitted to an immutable sequential listing may be validated by a set of validator nodes 300 associated with the immutable sequential listing. For example, and without limitation, transactions may be transmitted to one or more of the validator nodes 300 and may be shared between the validator nodes 300 for validation and consensus. In some embodiments, each validator node 302 determines whether a transaction is valid and whether the transaction complies with the rules of an immutable sequential listing. The validator node 302 may add a plurality of validated transactions to a data block and may submit the data block for consensus by all or some of the other validator nodes. 302 The other validator nodes 302 may vote “for” or “against” appending a data block containing transactions to an immutable sequential listing. A consensus of the set of validator nodes 300, e.g., a threshold number of identical votes “for” or “against”, is required to allow or deny the data block 102 to be appended to the blockchain 100. In some aspects, one or more of nodes 200 may also be validator nodes 302. In some aspects, nodes 200 that are not validator nodes 302 may perform processing such as, for example, receiving transaction submissions, providing member services, delivering events to applications, handling application programming interface (API) requests from users, or other similar functions. In this manner, the processing power of the validator nodes 302 may be preserved for generating new blocks, reaching consensus, and monitoring the other validator nodes 302. Validator nodes 302 may communicate with one another via communication pathways 304, e.g., wired or wireless connections, over the internet, etc., to transmit and receive data. For example, as new data blocks are generated by validator nodes 302, validator nodes 302 may communicate or share the new data blocks and may transmit and/or receive consensus messages via communication pathways 304.

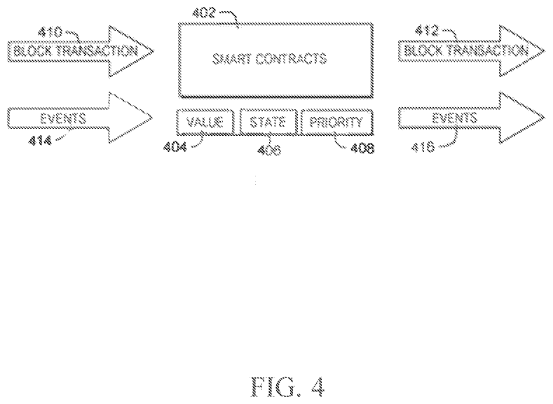

With reference now to FIG. 4, an example smart contract 402 is illustrated. A “smart contract” as used in this disclosure is a self-executing program that automates one or more actions required in an agreement. Smart contract 402 may include a value 404 (e.g., a numerical value, monetary value, or any other value), and/or a state 406 of the smart contract (e.g., a number of items of a product sold in all retail outlets of a firm, or other similar information that may be dependent on other sources). In some aspects, smart contract 402 may receive value 404 from a transaction in a block 410, or aggregated from multiple transactions in a block 410, and the value 404 may be sent to another smart contract via a transaction 412. Smart contract 402 may also receive information about the state 406 from an event 414, or aggregated from multiple events 414, and the state 406 may be sent as an event 416 to another smart contract.

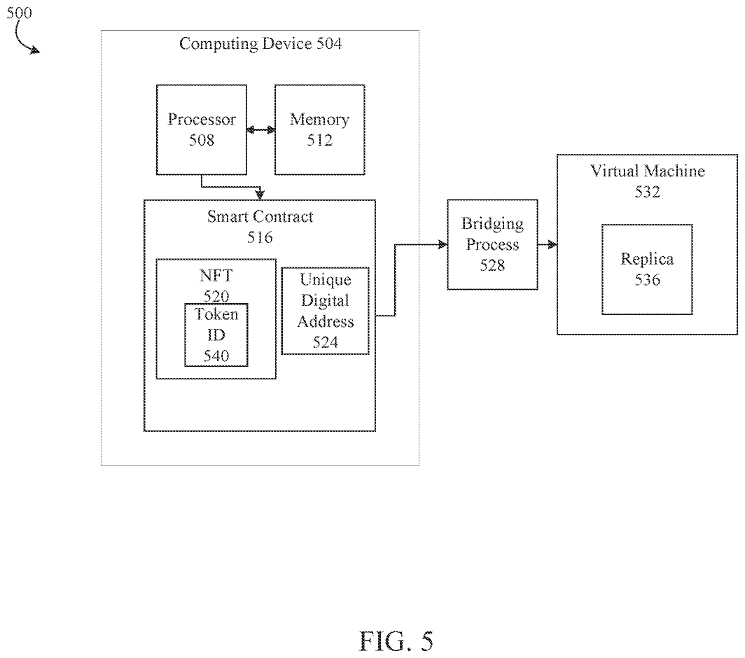

Referring now to FIG. 5, a block diagram showing an exemplary embodiment of a system 500 for managing smart contracts is presented. System 500 may include computing device 504. Computing device 504 may include processor 508 and/or memory 512. As used in this disclosure, “communicatively connected” means connected by way of a connection, an attachment, or a linkage between two or more relata which allows for reception and/or transmittance of information therebetween. For example, and without limitation, this connection may be wired or wireless, direct, or indirect, and between two or more components, circuits, devices, systems, and the like, which allows for reception and/or transmittance of data and/or signal(s) therebetween. Data and/or signals therebetween may include, without limitation, electrical, electromagnetic, magnetic, video, audio, radio, and microwave data and/or signals, combinations thereof, and the like, among others. A communicative connection may be achieved, for example and without limitation, through wired or wireless electronic, digital, or analog, communication, either directly or by way of one or more intervening devices or components. Further, communicative connection may include electrically coupling or connecting at least an output of one device, component, or circuit to at least an input of another device, component, or circuit. For example, and without limitation, via a bus or other facility for intercommunication between elements of a computing device. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure.

Still referring to FIG. 5, computing device 504 may include any computing device as described in this disclosure, including without limitation a microcontroller, microprocessor, digital signal processor (DSP) and/or system on a chip (SoC) as described in this disclosure. Computing device 504 may include, be included in, and/or communicate with a mobile device such as a mobile telephone or smartphone. Computing device 504 may include a single computing device operating independently, or may include two or more computing device operating in concert, in parallel, sequentially or the like; two or more computing devices may be included together in a single computing device or in two or more computing devices. Computing device 504 may interface or communicate with one or more additional devices as described below in further detail via a network interface device (not shown). Network interface device may be utilized for connecting computing device 504 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Computing device 504 may include but is not limited to, for example, a computing device or cluster of computing devices in a first location and a second computing device or cluster of computing devices in a second location. Computing device 504 may include one or more computing devices dedicated to data storage, security, distribution of traffic for load balancing, and the like. Computing device 504 may distribute one or more computing tasks as described below across a plurality of computing devices of computing device, which may operate in parallel, in series, redundantly, or in any other manner used for distribution of tasks or memory between computing devices. Computing device 504 may be implemented using a “shared nothing” architecture in which data is cached at the worker, in an embodiment, this may enable scalability of computing device 504 and/or another computing device.

With continued reference to FIG. 5, computing device 504, and/or any other computing device as described throughout this disclosure, may be designed and/or configured to perform any method, method step, or sequence of method steps in any embodiment described in this disclosure, in any order and with any degree of repetition. For instance, the processor 104 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Computing device 504 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Referring still to FIG. 5, computing device 504 may be configured to generate smart contract 516. Smart contract 516 may include a smart contract as described above with reference to FIGS. 1 and 4. Smart contract 516 may include one or more parameters. Parameters of smart contract 516 may include, without limitation, data types, storage types, memory variables, environment variables, internal functions, external functions, view functions, constructor functions, and the like. Computing device 504 may generate and/or adjust one or more parameters of smart contract 516 based on a variety of factors, such as, but not limited to, digital wall addresses, NFT 520 type, digital/physical assets associated with NFT 520, and the like. Smart contract 516 may include unique digital address 524. A “unique digital address” as used in this disclosure is a string of characters, symbols, and/or numbers identifying a digital asset. As a non-limiting example, a unique digital address of a digital wallet may include “1A1zP1eP5QGefi2DMPTfTL5SLmv7DivfNa”.

Computing device 504 may encrypt data of smart contract 516, such as, but not limited to, times, dates, values, digital ID's, addresses, smart contract parameters, and the like. Computing device 504 may encrypt data utilizing a hash function, such as the hash function described above with reference to FIG. 1. In some embodiments, computing device 504 may digitally sign hashed data of smart contract 516. Digitally signing hashed data of smart contract 516 may include providing digital identification, one or more cryptographic keys, and the like.

In some embodiments, smart contract 516 may include self-executable code that may mint or otherwise create non-fungible token (NFT) 520. Smart contract 516 may mint and/or create NFT 520 upon one or more conditions being met. For instance, and without limitation, a first party may transfer a form of value to a second party, upon which smart contract 516 may create NFT 520. NFT 520 may include any NFT as described throughout this disclosure, for example, with reference to FIG. 1 above, without limitation. NFT 520 may represent a physical asset. A “physical asset” as used in this disclosure is an object or objects having a mass. Physical assets may include, without limitation, articles of clothing, paintings, houses, and the like. NFT 520 may, in some embodiments, represent a digital asset. A “digital asset” as used in this disclosure is a virtual property. Digital assets may include, but are not limited to, digital art, digital characters, videos, and the like. NFT 520 may include a token identification (ID) 540. A “token identification” as used in this disclosure is a unique string of characters and/or symbols that identifies a digital token. Token ID 540 may be unique to NFT 520.

Computing device 504 may generate a digital wallet. A “digital wallet” as used in this disclosure is a software that stores and/or transmits transactional information. A digital wallet may automatically create one or more public/private key pairs. In some embodiments, a digital wallet may create one or more digital signatures. Computing device 504 may utilize a digital wallet to store one or more NFT's 520, smart contract 516, and/or other data. In some embodiments, computing device 504 may utilize a digital wallet to communicate with one or more other digital wallets, computing devices, and the like. For instance, computing device 504 may utilize a digital wallet to interact with a digital wallet of virtual machine 532, without limitation. Interaction between digital wallets may include, but is not limited to, exchanging of one or more public/private key pairs, NFTs 520, smart contracts 516, and the like.

In some embodiments, computing device 504 may identify a type of immutable sequential listing of NFT 520. Types of immutable sequential listings may include, without limitation, Ethereum, BSC, Avalanche, Polygon, and the like. Computing device 504 may assign a numerical value to a type of immutable sequential listing, such as, without limitation, 1, 2, 3, 4, and the like. Computing device 504 may hash one or more numerical values assigned to one or more types of immutable sequential listings. In some embodiments, computing device 504 may determine a bridge registry and/or contract source code address of smart contract 516. A “bridge registry” as used in this disclosure is an address and/or identity of a cryptographic bridge. A bridge registry may include, without limitation, one or more digital addresses, digital identifiers, and the like. A contract source code address of smart contract 516 may include a digital address of smart contract 516. In some embodiments, addresses of a bridge registry and contract source code of smart contract 516 may be hashed by computing device 504. Computing device 504 may further split byte code addresses into substrings based on, but not limited to, locations of bridge addresses. A contract type of smart contract 516 and/or a source code address of smart contract 516 may be stored within a hashed string generated by computing device 504.

In some embodiments, computing device 504 may engage in bridging process 528. A “bridging process” as used in this disclosure is a method of transferring digital assets between two or more immutable sequential listings. In some embodiments, bridging process 528 may include a crypto bridge. Bridging process 528 may include generating a second smart contract from data of smart contract 516 on virtual machine 532. A “virtual machine” as used in this disclosure is a digital computing environment. Virtual machine 532 may include, but is not limited to, the Ethereum Virtual Machine (EVM). In some embodiments, bridging process 528 may include a trusted bridge. A trusted bridge may depend upon a central entity or other system for operations. For instance, a trusted bridge may include external verifiers that may facilitate transfer of data and value. In some embodiments, bridging process 528 may include a trustless bridge. A trustless bridge may operate in a decentralized manner by utilizing smart contracts to manage interoperability processes. In some embodiments, bridging process 528 may include a unidirectional bridge. A unidirectional bridge may include a transfer path for cryptographic data from one network to another without a possibility of sending the crypto data back. In some embodiments, bridging process 528 may include a bi-directional bridge. A bi-directional bridge may include a two-way transfer of data and cryptographic assets between two or more networks. Computing device 504 may transfer data of smart contract 516 to virtual machine 532 through bridging process 528.

Still referring to FIG. 5, computing device 504 may combine or otherwise aggregate data of smart contract 516 and/or NFT 520 into a packed string. Computing device 504 may hash a packed string containing data of smart contract 516 and/or NFT 520. In some embodiments, deployment of smart contract 516 onto virtual machine 532 through bridging process 528 may include running a check to confirm no prior contract has been deployed using the same data as that of smart contract 516 and/or NFT 520. Computing device 504 may halt deployment of smart contract 516 onto virtual machine 532 if the same data of smart contract 516 has been previously used. Computing device 504 may utilize a hash produced from data of smart contract 516 as a salt in a deployment function of smart contract 516. A “salt” when referring to a smart contract as used in this disclosure is a value added to a function to make discovering a secret key harder. Salts in smart contracts may include arbitrary values, such as 1, 10, and the like. In some embodiments, computing device 504 may utilize smart contact 516 and/or hashed data of smart contract 516 as a salt in a smart contract deployment onto virtual machine 532. By using the data of smart contract 516 as a salt value, an identical smart contract to that of smart contract 516 may be deployed. For instance, computing device 504 may deploy a smart contract having the same data as smart contract 516 onto virtual machine 532 through bridging process 528. Computing device 504 may use a CREATE2 function to deploy smart contract 516 onto virtual machine 532. The CREATE2 function may include a software function that deploys a smart contract at a precomputed address. For instance, a CREATE2 function may be programmed to generate a new address as a function of 0xFF, a sender's own digital address, a salt, and a deployable bytecode. 0xFF may be a constant that may prevent collisions with any CREATE function. A CREATE2 function may be represented by the following equation, “new_address=hash(0xFF, sender, salt, bytecode)”. Computing device 504 may combine any relevant data packed in between a substring of smart contract 516 and deploy the relevant data onto virtual machine 532, such as through the CREATE2 function as described above. Relevant data may include, without limitation, addresses, token ID's, recipient identification, digital signatures, and/or other data. In some embodiments, deploying smart contract 516 through bridging process 528 may include updating a standards enforcer contract with the new bridgeable contract address of smart contract 516, which may allow smart contract 516 exclusive use of the standards enforcer contract.

In some embodiments, one or more parameters of smart contract 516 may be hashed and signed by a digital wallet and/or private key. The hashed parameters may be passed to an initial smart contract with a signature included. The configurations may be hashed, and the signature may be validated. In some embodiments, once validated, the hash may be used as a salt in a smart contract, which may allow for a proxy contract capable of loading a pre-configured smart contract with an initial wallet's source code. In some embodiments, a validation and/or facilitation for a proxy contract may be accomplished by utilizing a recovery function on an elliptic curve digital signature algorithm (ECDSA) signature made by a private key of a wallet that created original smart contract 516 configurations.

In some embodiments, once smart contract 516 is deployed in virtual machine 532, smart contract 516 may produce replica 536 of NFT 520. Replica 536 may be minted and/or created through deployment of smart contract 516. In some embodiments, by deploying smart contract 516 onto virtual machine 532 using the data of smart contract 516 as a salt in a CREATE2 function, an exact copy of smart contract 516 and NFT 520 may be deployed. For instance, replica 536 may include the same token ID 540 of NFT 520 and smart contract 516 deployed onto virtual machine 532 may include the same unique digital address 524. In some embodiments, computing device 504 may ensure only one replica 536 is active at a time. For instance, computing device 504 may either lock NFT 520 or burn NFT 520 so that only replica 536 remains, without limitation. As a non-limiting example, NFT 520 may exist on immutable sequential listing A and virtual machine 532 may include immutable sequential listing B. Through bridging process 528, smart contract 516 may be deployed onto immutable sequential listing B of virtual machine 532 and mint and/or create replica 536 of NFT 520. Computing device 504 may lock or burn NFT 520 on immutable sequential listing A so that only immutable sequential listing B of virtual machine 532 remains. In some embodiments, replica 536 may already exist on virtual machine 532. In this case, and without limitation, computing device 504 may unlock replica 536 of virtual machine 532 through deployment of smart contract 516 onto virtual machine 532 through bridging process 528 and lock or burn NFT 520.

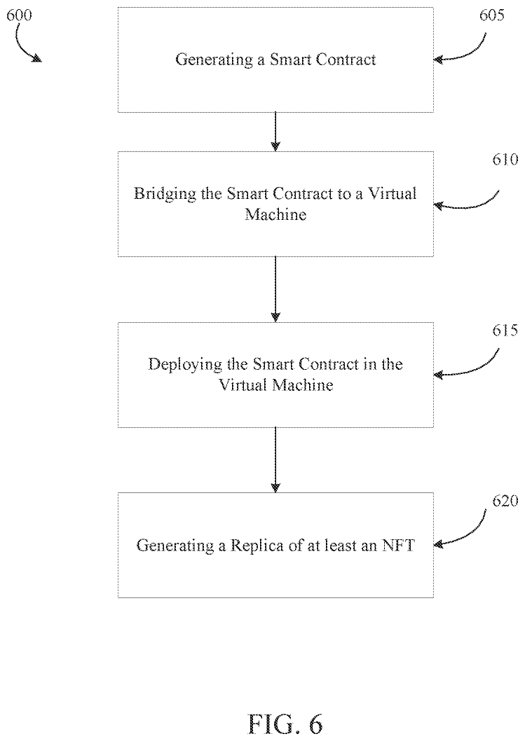

Referring now to FIG. 6, a flowchart of a method 600 for managing smart contracts is presented. At step 605, method 600 includes generating a smart contract. A smart contract may be generated by a computing device. In some embodiments, a smart contract may include an NFT and/or unique digital address. Generating a smart contract may include generating one or more parameters of a smart contract, such as values, states, events, conditions, and the like. A smart contract may have a unique digital address. In some embodiments, a smart contract may include executable code that produces an NFT upon execution. This step may be implemented, without limitation, as described above in FIGS. 1-5.

Still referring to FIG. 6, at step 610, method 600 includes bridging the smart contract to a virtual machine. Bridging the smart contract may include utilizing one or more cryptographic bridges between two or more devices, such as virtual machines. Bridging may include utilizing a trusted, trustless, or other bridging system. Bridging the smart contract may include transferring data of the smart contact and/or the smart contract itself to one or more virtual machines. In some embodiments, hashed data of the smart contact is bridge to one or more virtual machines. This step may be implemented, without limitation, as described above with reference to FIG. 5.

Referring still to FIG. 6, at step 615, method 600 includes deploying the smart contract in the virtual machine. The smart contract may be deployed using a CREATE2 function, as described above with reference to FIG. 5. Deploying the smart contract may include verifying similar or the same data of the smart contract has not been previously deployed at the virtual machine. In some embodiments, if same or similar data is detected, deployment of the smart contract may be halted. Deploying the smart contract may include utilizing data of the smart contract as a slat in a CREATE2 function which may allow reproduction of the smart contract including a unique digital address of the smart contract. This step may be implemented as described above with reference to FIG. 5, without limitation.

Still referring to FIG. 6, at step 620, method 600 includes generating a replica of at least an NFT. An NFT may include any NFT as described throughout this disclosure, without limitation. In some embodiments, generating a replica of at least an NFT includes minting and/or otherwise creating a replica of an NFT from a smart contract bridged to a virtual machine. For instance, the smart contract may include executable code that may mint or otherwise create a replica of an original NFT. In some embodiments, a computing device may lock or erase an original NFT upon creation of the replica of at least an NFT. In other embodiments, generating a replica of at least an NFT may include unlocking a pre-existing NFT on a virtual machine and burning or locking an original NFT from a transferring machine. This step may be implemented as described above with reference to FIG. 5, without limitation.

Method steps of the techniques described herein can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. One or more memories can store media assets (e.g., audio, video, graphics, interface elements, and/or other media files), configuration files, and/or instructions that, when executed by a processor, form the modules, engines, and other components described herein and perform the functionality associated with the components. The processor and the memory can be supplemented by, or incorporated in special purpose logic circuitry.

It should also be noted that the present implementations can be provided as one or more computer-readable programs embodied on or in one or more articles of manufacture. The article of manufacture can be any suitable hardware apparatus. In general, the computer-readable programs can be implemented in any programming language. The software programs can be further translated into machine language or virtual machine instructions and stored in a program file in that form. The program file can then be stored on or in one or more of the articles of manufacture.

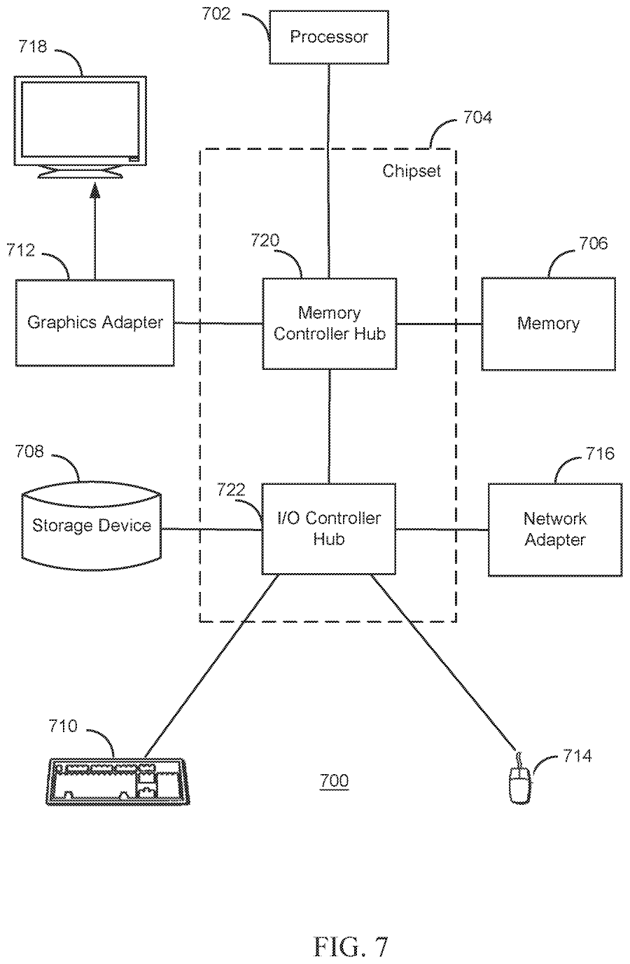

FIG. 7 illustrates an example of a computing device in the exemplary form of a computer system 700 within which a set of instructions for causing a control system to perform any one or more of the aspects and/or methodologies of the present disclosure may be executed. In some embodiments, the computing system 700 includes at least one processor 702 coupled to a chipset 704. The chipset 704 includes a memory controller hub 720 and an input/output (I/O) controller hub 722. A memory 706 and a graphics adapter 712 are coupled to the memory controller hub 720, and a display 718 is coupled to the graphics adapter 712. A storage device 708, an input interface 714, and network adapter 716 are coupled to the I/O controller hub 722. Other embodiments of the computing device 108 have different architectures.

In some embodiments, the storage device 708 is a non-transitory computer-readable storage medium such as a hard drive, compact disk read-only memory (CD-ROM), DVD, or a solid-state memory device. The memory 706 holds instructions and data used by the processor 702. The input interface 714 is a touch-screen interface, a mouse, track ball, or other type of input interface, a keyboard, or some combination thereof, and is used to input data into the computing system 700. In some embodiments, the computing system 700 may be configured to receive input (e.g., commands) from the input interface 714 via gestures from the user. The graphics adapter 712 displays images and other information on the display 718. For example, the display 718 can show an indication of a predicted cell trajectory. The network adapter 716 couples the computing device 108 to one or more computer networks.

The computing system 700 is adapted to execute computer program modules for providing functionality described herein. As used herein, the term “module” refers to computer program logic used to provide the specified functionality. Thus, a module can be implemented in hardware, firmware, and/or software. In one embodiment, program modules are stored on the storage device 708, loaded into the memory 706, and executed by the processor 702.

The types of computing devices of computing system 700 can vary from the embodiments described herein. For example, the computing system 700 can lack some of the components described above, such as graphics adapters 712, input interface 714, and displays 718. In some embodiments, a computing system 700 can include a processor 702 for executing instructions stored on a memory 706.

Computer system 700 may include a processor 702 and a memory 706 that communicate with each other and/or with other components, via a bus. A bus may include any of several types of bus structures including, but not limited to, a memory bus, a memory controller, a peripheral bus, a local bus, and any combinations thereof, using any of a variety of bus architectures. Memory 706 may include various components (e.g., machine-readable media) including, but not limited to, a random-access memory component, a read only component, and any combinations thereof. In some embodiments, a basic input/output system (BIOS), including basic routines that may help to transfer information between elements within computer system 700, such as during start-up, may be stored in memory 706. Memory 706 may also include (e.g., stored on one or more machine-readable media) instructions (e.g., software) embodying any one or more of the aspects and/or methodologies of the present disclosure. In some embodiments, memory 706 may further include any number of program modules including, but not limited to, an operating system, one or more application programs, other program modules, program data, and any combinations thereof.

Computer system 700 may also include a storage device 708. Examples of a storage device 708 include, but are not limited to, a hard disk drive, a magnetic disk drive, an optical disc drive in combination with an optical medium, a solid-state memory device, and any combinations thereof. Storage device 708 may be connected to a bus by an appropriate interface. Example interfaces include, but are not limited to, SCSI, advanced technology attachment (ATA), serial ATA, universal serial bus (USB), IEEE 1394 (FIREWIRE), and any combinations thereof. In one example, storage device 708 (or one or more components thereof) may be removably interfaced with computer system 700 (e.g., via an external port connector. Particularly, storage device 708 and an associated machine-readable medium may provide nonvolatile and/or volatile storage of machine-readable instructions, data structures, program modules, and/or other data for computer system 700. In one example, software 720 may reside, completely or partially, within machine-readable medium 728. In another example, software 720 may reside, completely or partially, within processor 704.

Computer system 700 may also include an input device, such as keyboard 710 and/or input interface 714. In one example, a user of computer system 700 may enter commands and/or other information into computer system 700 via an input device, such as input interface 714. Examples of an input device include, but are not limited to, an alpha-numeric input device (e.g., a keyboard 710), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. An input device of input interface 714 may be interfaced to a bus of computing system 700 via any of a variety of interfaces (not shown) including, but not limited to, a serial interface, a parallel interface, a game port, a USB interface, a FIREWIRE interface, a direct interface to a bus, and any combinations thereof. Input interface 714 may include a touch screen interface that may be a part of or separate from display 718, discussed further below. Input interface 714 may be utilized as a user selection device for selecting one or more graphical representations in a graphical interface as described above.

In some embodiments, a user may also input commands and/or other information to computer system 700 via storage device 708 (e.g., a removable disk drive, a flash drive, etc.) and/or network adapter 716. A network interface device, such as network adapter 716, may be utilized for connecting computer system 700 to one or more of a variety of networks and one or more remote devices connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 744, may employ a wired and/or a wireless mode of communication. In general, any network topology may be used. Information (e.g., data, software, etc.) may be communicated to and/or from computer system 700 via network adapter 716.

Computer system 700 may further include a video display adapter, such as graphics adapter 712, for communicating a displayable image to a display device, such as display device 718. Examples of a display device include, but are not limited to, a liquid crystal display (LCD), a cathode ray tube (CRT), a plasma display, a light emitting diode (LED) display, and any combinations thereof. Graphics adapter 712 and display device 718 may be utilized in combination with processor 702 to provide graphical representations of aspects of the present disclosure. In addition to a display device, computer system 700 may include one or more other peripheral output devices including, but not limited to, an audio speaker, a printer, and any combinations thereof. Such peripheral output devices may be connected to a bus via a peripheral interface. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. An apparatus for managing smart contracts, comprising:
at least a processor; and
a memory communicatively connected to the at least a processor, the memory containing instructions configuring the at least a processor to:
generate a smart contract, wherein the smart contract comprises:
at least a non-fungible token (NFT) having a unique token identification; and
a unique digital address;
bridging the smart contract to a virtual machine; and
deploying the smart contract, wherein upon deployment a replica of the at least a NFT is generated, wherein the replica has the same unique token identification as the at least a non-fungible token.

2. The apparatus of claim 1, wherein the bridging process includes utilizing one of a trusted bridge or a trustless bridge.

3. The apparatus of claim 1, wherein the at least a processor is further configured to either lock or burn the at least a NFT upon deployment of the smart contract.

4. The apparatus of claim 1, wherein the at least a processor is further configured to unlock a pre-existing replica of the at least a NFT in the virtual machine upon deployment of the smart contract.

5. The apparatus of claim 1, wherein the unique digital address and the unique token identification of the smart contract are maintained through the bridging process.

6. The apparatus of claim 1, wherein the at least a processor is further configured to:
verify a prior smart contract having data the same as the smart contract has not been deployed on the virtual machine;
hashing the data of the smart contract and combining the data with a bridge registry address; and
deploying the smart contract onto the virtual machine.

7. The apparatus of claim 6, wherein the smart contract is deployed using a CREATE2 function.

8. The apparatus of claim 1, wherein the at least a processor is further configured to identify a type of immutable sequential listing of the at least an NFT; and
assign a numeric value to the type of immutable sequential listing of the at least an NFT.

9. The apparatus of claim 8, wherein the at least a processor is further configured to hash the numerical value assigned to the type of immutable sequential listing of the at least a NFT.

10. The apparatus of claim 1, wherein the at least a processor is further configured to utilize data of the smart contract as a salt in a smart contract creation function.

11. A method of managing smart contracts using a computing device, comprising:
generating, at the computing device, a smart contract, wherein the smart contract comprises:
at least a non-fungible token (NFT) having a unique token identification; and
a unique digital address;
bridging the smart contract to a virtual machine; and
deploying the smart contract, wherein upon deployment a replica of the at least a NFT is generated, wherein the replica has the same unique token identification as the at least a non-fungible token.

12. The method of claim 11, wherein bridging comprises utilizing one of a trusted bridge or a trustless bridge.

13. The method of claim 11, further comprising either locking or burning the at least a NFT upon deployment of the smart contract.

14. The method of claim 11, further comprising unlocking a pre-existing replica of the at least a NFT in the virtual machine upon deployment of the smart contract.

15. The method of claim 11, wherein the unique digital address and the unique token identification of the smart contract are maintained through the bridging process.

16. The method of claim 11, further comprising:
verifying a prior smart contract having data the same as the smart contract has not been deployed on the virtual machine;
hashing the data of the smart contract and combining the data with a bridge registry address; and
deploying the smart contract onto the virtual machine.

17. The method of claim 16, wherein the smart contract is deployed using a CREATE2 function.

18. The method of claim 11, further comprising identifying a type of immutable sequential listing of the at least an NFT; and
assigning a numeric value to the type of immutable sequential listing of the at least an NFT.

19. The method of claim 18, further comprising hashing the numerical value assigned to the type of immutable sequential listing of the at least a NFT.

20. The method of claim 11, further comprising generating a salt from data of the smart contract in a smart contract creation function.
